(19) United States
(12) Patent Application Publication
(10) Pub. No.: US 2007/0269031 A1
(43) Pub. Date: Nov. 22, 2007

(54) Method and apparatus for distributing advertisements to callers during telephone calls

(76) Inventors: Edward Honig, Lawrence, NY (US); Elly Rosenbaum, Passaic, NJ (US)

Correspondence Address: EDELL, SHAPIRO & FINNAN, LLC, 1901 RESEARCH BOULEVARD, SUITE 400, ROCKVILLE, MD, 20850, US

(21) Appl. No.: 11/783,109

(22) Filed: Apr. 5, 2007

Related U.S. Application Data
(60) Provisional application No. 60/789,149, filed on Apr. 5, 2006.

(51) Int. Cl. H04M 7/00

(52) U.S. Cl. 379/142.01

(57) ABSTRACT

The present invention embodiments receive remote access to a telephone line of an organization and download information to calling parties. The organizations providing remote access earn revenue based on various criteria. A present invention embodiment places callers to the organization telephone system into a conference call for transference to a service provider advertising system to provide the call with advertising information. Alternatively, a dedicated line in the organization telephone system may be utilized for the call routing. A live downfeed or other material is provided to the calling parties, where specific wait queues are established for callers with each queue associated with a particular time interval. Callers may be screened in order to determine the time interval each caller receives advertisements. Upon expiration of the designated queue time and completion of an advertisement, the caller is returned to the organization telephone system to be connected with an organization representative.

### CROSS-REFERENCE TO RELATED APPLICATIONS

This application claims priority from U.S. Provisional Patent Application Ser. No. 60/789,149, entitled “Method and Apparatus for Distributing Advertisements to Callers During Telephone Calls” and filed Apr. 5, 2006, the disclosure of which is incorporated herein by reference in its entirety.

### BACKGROUND OF THE INVENTION

1. Technical Field

The present invention pertains to telephone call handling. In particular, the present invention pertains to a system (e.g., hardware and/or software related) and method of distributing advertisements to telephone calls intended for and/or received at an organization premises.

2. Discussion of Related Art

Currently, millions of telephone calls are received daily by government offices, organizations, and corporate and miscellaneous businesses. These organizations are committed to providing services to customers or citizens, and employ service or call centers to accommodate the influx of telephone calls. Typically, the call capacity of these organizations rapidly becomes exhausted and callers are requested to hold or remain on the line for a period of time. This “on hold” time may range from under a minute to well over ninety minutes. Since the purpose of these telephone calls is generally to obtain information to resolve issues, the nature of the calls requires callers to wait in order to converse with a representative of the called organization.

However, callers may eventually become frustrated and terminate the call or hang-up in order to seek comparable services from organization competitors. This has created a burden for the organizations to provide the necessary call services with many seeking ways to alleviate that burden. Accordingly, the organizations are concerned with lessening the wait time and/or entertaining or preoccupying the callers. For example, technology is assisting with the reduction of wait times with advanced distributing software. Further, several types of entertainment may be provided to the callers over the telephone line during the waiting period. The entertainment may include music, local radio stations, and offerings or programs of the called organization (e.g., the latest mortgage plans of a financial organization being called, etc.). In addition, some organizations may outsource call centers to avoid these types of problems altogether.

Although outsourcing call centers and employing technology may lessen the caller wait time, organizations are forfeiting a prime source of advertising revenue.

### SUMMARY OF THE INVENTION

Accordingly, the present invention embodiments seek to capitalize on the revenue stream that the related art is forfeiting due to reduced call wait times. If wait times are increased, the called organization creates a large customer base of calling parties. For example, assume company A receives one million calls a day with an average wait time of forty seconds. Company A may offer company B to advertise to the callers giving company B access to the telephone lines for the first thirty second time period that callers are waiting. Company A may receive an annual fee of $10,000 dollars as advertising revenue. If company A announces that due to unusually large call volume, the wait time is approximately four minutes, the revenue earned by company A may significantly increase.

In particular, the present invention embodiments receive remote access to a telephone line of an organization and download advertising to parties calling the organization. The order of advertisements may be controlled for each caller. Sponsors may pay fees to advertise to the waiting callers based on priority placements and specific demographic locations (e.g., a social security office includes an older demographic for the majority of their calls, etc.). The organizations that provide the remote access may earn revenue based on the quantity of calls, quantity of advertisements and/or a fixed fee arrangement (e.g., an annual contract, etc.). Thus, the present invention embodiments provide an opportunity for an organization to add an additional facet of revenue to their business model. This can be employed by any organization with a customer base that places telephone calls to the organization for services, information and/or any other purposes.

The present invention embodiments may require a caller to listen to a certain minimum number of advertisements in order to converse with a representative of the called organization. A present invention embodiment may place callers intended for the organization telephone system into a conference type call and transfer the call to an advertising system or central office of a service provider with the original organization still retaining access to the call or line. The advertising system subsequently provides the call with the proper advertising based on the contractual or other arrangement with that organization. Once completed, the advertising system returns the call back to the telephone system (e.g., an Interactive Voice Response (IVR) or Automatic Call Distributor (ACD) system, call center, etc.) of the organization for handling in accordance with the normal organization call handling procedures or policies of that system. This embodiment basically transfers the calls for advertisements prior to the organization telephone system employing the normal organization call handling procedures to handle the call and independent of the availability of organization representatives. Alternatively, the organization may dedicate a line in the organization telephone system for direct routing of the call to the advertising system of the service provider according to an embodiment of the present invention. In this case, the organization may route received incoming calls from the organization telephone system to the dedicated line prior to or during normal call handling procedures and independent of the availability of organization representatives. The advertising system may be networked with one or more organizations via their corresponding telephone systems.

The advertising system of the present invention embodiments provides a live downfeed or other material to the calling parties. The advertising system basically provides commercial advertising on a real time basis to the calling parties, and further controls and tracks the advertisements in order to determine revenues for each organization based on the quantity of callers and/or advertisements. Thus, if the organization can persuade a customer to place a telephone call to the organization, this may lead to an enhanced revenue stream.

The present invention embodiments may establish specific wait queues for callers with each wait queue associated with a particular time interval. Callers may be screened in order to determine the time interval each caller receives advertisements. For example, if the customer is calling an organization due to a system failure, this caller may be placed in a queue with a longer wait time since the caller needs to resolve the issue and is likely to wait for extended periods. If the designated queue time expires, the caller remains in the queue until completion of a current advertisement. In other words, an advertisement is not interrupted due to expiration of the associated queue time interval. This provides sponsors or advertisers some assurance that their advertisements are being received by callers in their entireties. The advertisements may constantly change and may run on the same advertising sales platforms as radio and television.

Upon expiration of the designated queue time and completion of a current advertisement, the caller is returned to the organization telephone system (for implementation of normal organization call handling procedures by that system) in order to be connected with an organization representative. If the representative needs to place the caller on-hold (e.g., to obtain information), the caller may be routed to the advertising system and placed on a queue with a short time interval to receive advertisements as described above.

The above and still further features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1 is a diagrammatic illustration of a network topology employed by a present invention embodiment to distribute advertisements to calls.

FIG. 2 is a flow diagram illustrating the manner in which advertising is distributed to callers according to an embodiment of the present invention.

FIG. 3 is a procedural flow chart illustrating the manner in which calls are handled for advertising by an advertising system according to an embodiment of the present invention.

### DETAILED DESCRIPTION OF THE PREFERRED EMBODIMENTS

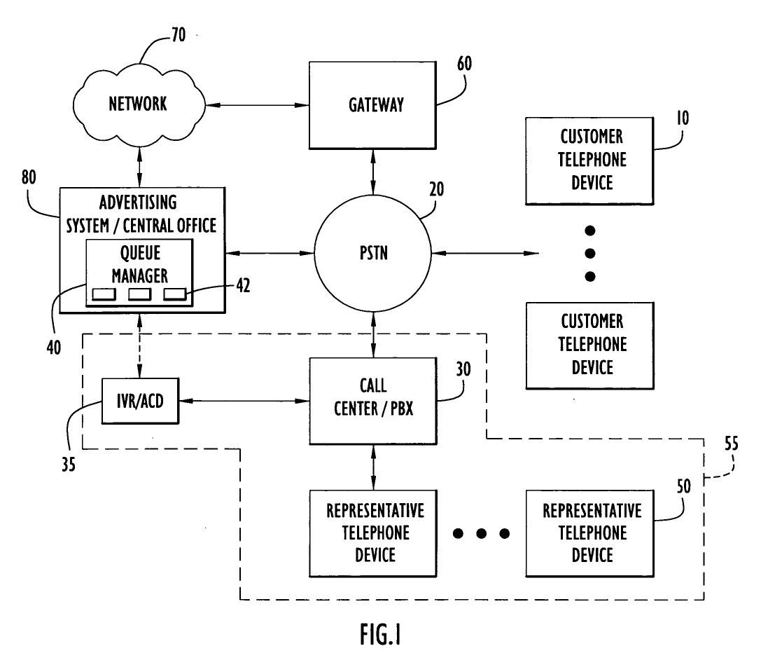

An exemplary network topology for distributing advertising or other material to waiting callers according to a present invention embodiment is illustrated in FIG. 1. Specifically, the topology includes a telephone network 20, a call center unit or Private Branch Exchange (PBX) 30, an Interactive Voice Response (IVR) or Automatic Call Distributor (ACD) system 35, a gateway unit 60, a communications network 70 and an advertising system 80 with a corresponding queue manager unit 40. Telephone network 20 is preferably implemented by a conventional Public Switched Telephone Network (PSTN) and is coupled to one or more customer telephone or communication devices 10. The telephone network basically facilitates placement of calls by users.

Telephone network 20 is further coupled to call center unit or Private Branch Exchange (PBX) 30 typically associated with, or residing in a facility of, a company or organization. The call center preferably includes conventional processing and/or telephone equipment (e.g., processors, switches, circuitry, etc.), and receives calls from the telephone network for distribution as described below.

IVR or ACD system 35 may be coupled to or integral with call center unit 30 to interact with and/or distribute calls received by the call center unit in accordance with organization call handling procedures or policies and/or in accordance with user responses to provided options as described below. The IVR or ACD system preferably includes conventional processing and/or telephone equipment (e.g., processors, switches, circuitry, etc.) and is further coupled to advertising system 80. One or more representative telephone or communication devices 50 are coupled to call center unit 30 to receive telephone calls placed by customer telephone devices 10 to the company or organization. Call center unit 30, IVR/ACD system 35 and representative telephone devices 50 basically form an organization telephone system 55 that handles calls in accordance with call handling procedures predetermined by the system and/or organization.

Telephone network 20 may further be coupled to communications network 70 via gateway unit 60. The communications network may be implemented by any quantity of any suitable communications media (e.g., WAN, LAN, Internet, Intranet, etc.), while the gateway unit preferably includes conventional processing, telephone and/or communications equipment (e.g., processors, routers, etc.) to facilitate communications between the telephone and communication networks.

Generally, a user places a telephone call to a company or organization via telephone device 10. For example, the telephone call may be for the purpose of ascertaining assistance and/or information with respect to a particular matter (e.g., customer support or service, government or other agency, etc.). Telephone network 20 routes the call to call center unit 30 of the appropriate organization. If a representative is available to accommodate the call, the call is transferred by the call center unit to a telephone device 50 of the available representative. Otherwise, the call is placed in a hold queue until a representative becomes available to accommodate the call. Alternatively, the call may be provided to IVR system 35 to interact with and/or entertain the caller until a representative becomes available.

The related art is concerned with lessening the wait time and/or entertaining or preoccupying waiting callers as described above. However, the present invention embodiments seek to capitalize on the revenue stream from advertising during call wait times that the related art is forfeiting by reducing the call wait times. In particular, advertising system 80 may be coupled to communications network 70, telephone network 20 and/or IVR or ACD system 35. The advertising system may be implemented by any quantity of any conventional or other computer system, preferably equipped with a display or monitor, a base (e.g., including the processor, memories and/or internal or external communications devices (e.g., modem, network cards, etc.)) and optional input devices (e.g., a keyboard, mouse or other input device), and/or by any conventional or other telephony and/or network communications equipment (e.g., router, processors, switches, circuitry, etc.). The advertising system is typically associated with a service provider that provides advertisements of sponsors (e.g., other companies or organizations, advertisements of the called organization, etc.) to waiting callers of an organization in return for a prearranged fee from the sponsors.

Advertising system 80 receives remote access to calls from call center unit 30 (e.g., via telephone network 20). In this case, calls intended for the organization may be provided to the advertising system in the form of a conference type call to enable the organization telephone system to retain some control of the call or line. Alternatively, the organization may utilize a dedicated or private line in the organization telephone system for direct access to the advertising system. For example, the organization may utilize a dedicated or private line to directly couple the IVR system to the advertising system. Further, the IVR system and call center unit may communicate with advertising system 80 via telephone network 20 and/or gateway unit 60 and communications network 70. In addition, the advertising system may reside locally with respect to the organization with the call center and/or IVR system directly connected to the advertising system. Advertising system 80 includes queue manager unit 40 to place calls received by the advertising system in appropriate wait queues. In particular, advertising system 80 receives calls from the organization telephone system and provides the calls to queue manager unit 40. The queue manager unit maintains one or more queues 42 for the received calls. The queues are each associated with a predetermined time interval and the queue manager unit ensures that each call remains in the respective queue for the associated time interval (e.g., a call placed in a queue associated with a ten minute time interval remains in the queue for at least ten minutes, etc.) to receive advertising content and/or respond to inquiries. The advertising system provides a live downfeed or other material to the waiting calling parties within the queues as described below. The queue manager unit basically determines placement of a call in a queue in a manner to maximize the wait time for each caller prior to a caller threshold for terminating the call, thereby enhancing the advertising time and consequently the revenue stream for the service provider and/or organization. The queue manager unit preferably includes conventional processing and/or telephone or call hold equipment (e.g., processors, switches, circuitry, etc.). The advertising system may communicate with any quantity of organizations and/or their corresponding telephone systems to provide advertisements or messages to waiting callers in substantially the same manner described below.

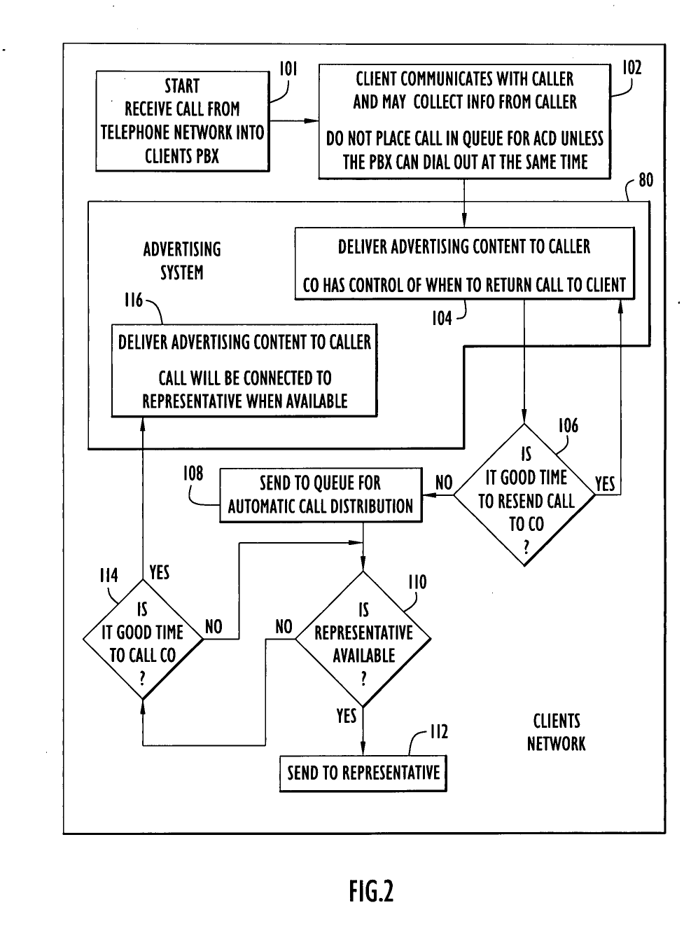

The manner in which a call is handled according to an embodiment of the present invention is illustrated in FIG. 2. Specifically, call center unit or Private Branch Exchange (PBX) 30 of an organization receives a call at step 101 from customer telephone device 10 via telephone network 20. The call may be routed from PBX 30 to advertising system 80 via telephone network 20 and/or gateway unit 60 and communications network 70 as described above. Alternatively, the organization may communicate with and/or collect information from the caller via IVR system 35 at step 102. The call is typically placed in the queue of the IVR system in response to PBX 30 being able to simultaneously dial out. In this case, IVR system 35 transfers the call to advertising system 80 as described above. The call is typically transferred from the call center unit or IVR system in the form of a conference type call to enable the organization to retain some control of the call or line for receiving the call back from the advertising system once advertising content has been provided to the caller as described below. This basically enables transfer of the calls for advertisements prior to the organization telephone system employing the normal organization call handling procedures to handle the call. In addition, the call is transferred from the organization telephone system to the advertising system independent of the availability of an organization representative to accommodate the call (e.g., even if a representative is available to handle the call).

Alternatively, the organization may dedicate a line in the organization telephone system for direct routing of the call to the advertising system of the service provider. In this case, the organization may route received incoming calls from the organization telephone system (e.g., IVR, PBX, etc.) to the dedicated line prior to or during normal call handling procedures and independent of the availability of organization representatives.

The advertising system provides advertising content to the received calls at step 104 and controls transfer of the call back to the organization telephone system (e.g., to IVR or ACD system 35 or to call center unit 30) at step 106. If the call is to be maintained by the advertising system as determined at step 106, the call is retained by advertising system 80 and provided with further advertising content. When the call is to be returned to the organization telephone system as determined at step 106 (e.g., sufficient advertising content has been provided to the call, etc.), the call is returned to IVR or ACD system 35 or call center unit 30 (e.g., via telephone network 20) of the organization at step 108 for handling in accordance with the organization normal call handling procedures or policies. For example, a call returned to call center unit 30 may be placed on hold, or provided to IVR system 35 to interact with the caller or to provide entertainment until an organization representative becomes available as determined at step 110. Further, the returned call may be provided to representative telephone device 50 at step 112 in response to an available representative as determined at step 110.

When an organization representative is unavailable to accommodate the returned call as determined at step 110, the call may be provided to advertising system 80 from IVR system 35 or call center unit 30 of the organization telephone system at step 114 to receive further advertising content at step 116. In this case, the call may be returned to the organization telephone system when a representative becomes available, and the caller controls the amount of advertising to be provided (e.g., caller controls when to return to the organization telephone system based on caller input). In addition, the caller may relinquish this control (e.g., based on caller input) and enable the advertising system to control return of the call to the organization telephone system as described above.

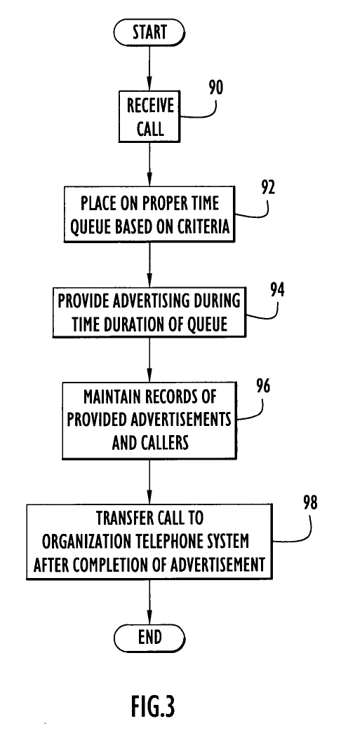

The manner in which the advertising system provides advertising content to a caller is illustrated in FIG. 3. Initially, an organization enters an arrangement with the service provider and provides access to the organization telephone system (e.g., conference call, dedicated line, etc.) as described above. A caller places a call to the organization via customer telephone device 10, and telephone network 20 routes the call to call center unit or Private Branch Exchange (PBX) 30 as described above. The call center receives the call, where the call is transferred to advertising system 80 via the call center unit or IVR system 35 as described above independent of the availability of organization representatives to handle the call. The caller may be screened or placed on a queue for presentation of inquiries by IVR system 35 to ascertain and/or store caller information as described above. Alternatively, a call may be transferred to the advertising system for placement on a queue 42 based on availability of organization representatives (e.g., a call may be transferred to a representative if initially available, or transferred to the advertising system in the event all representatives are unavailable (e.g., the caller is placed on-hold)).

The advertising system receives the call at step 90 and provides the call to queue manager unit 40. The queue manager unit maintains one or more queues 42 for the received calls. The queues are each associated with a predetermined time interval and the queue manager unit ensures that each call remains in the respective queue for the associated time interval (e.g., a call placed in a queue associated with a ten minute time interval remains in the queue for at least ten minutes, etc.). The queues may be associated with any desired time intervals based on a particular application (e.g., any desired time increments, seconds, minutes, half-four, hour, etc.). One or more queues 42 may be utilized to ascertain information from callers. In particular, advertising system 80 may present inquiries to callers within these queues to obtain specific caller information (e.g., age, weight, height, ethnicity, telephone number, e-mail address, demographics, address, caller preferences or interests, purpose of the call, etc.). The information retrieved from the callers may be stored within advertising system 80 and/or queue manager unit 40.

When a call is transferred to the queue manager unit (or after completing the inquiries), the queue manager unit may retrieve the caller information and place the caller in an appropriate queue based on an analysis of the information at step 92. Alternatively, each received call may be screened by advertising system 80 in order to determine the queue placement or time interval each caller receives advertisements. The queue manager unit basically determines placement of a call in a queue in a manner to maximize the wait time for each caller prior to a caller threshold for terminating the call, thereby enhancing the advertising time and consequently the revenue stream for the service provider and/or organization. For example, if the customer is calling an organization due to a server failure, this caller may be placed in a queue with a longer wait time since the caller needs to resolve the issue and is likely to wait for extended periods. Further, if a caller is retired, the caller may be placed in a queue with a longer wait time since this caller may have a flexible schedule and is willing to wait for a loner period of time.

The advertising system preferably stores the advertisements or messages for presentation to the callers within the queues. Further, advertising system 80 may similarly utilize the caller information to select appropriate advertisements or messages for each caller. For example, advertisements may be presented for products related to caller interests. The advertisements may constantly change and may run on the same advertising sales platforms as radio and television. Advertising system 80 retrieves messages or advertisements based on the caller information and/or based on a sponsor priority and presents the retrieved advertisements to the caller for the duration of the time interval associated with the caller queue at step 94.

The advertising system further controls and tracks the advertisements in order to determine revenues for the organization based on the quantity of callers and/or advertisements at step 96. In particular, the advertising system may select and/or control the order of advertisements presented to each caller. Sponsors may pay fees to the service provider to advertise to the waiting callers based on priority or order of advertisements (e.g., presented first, last, etc.) and specific demographic locations (e.g., a social security office includes an older demographic for the majority of their calls, etc.). The organization providing the remote access to the service provider may receive or share revenue based on the quantity of calls, quantity of advertisements presented and/or a fixed fee arrangement (e.g., an annual contract, etc.). Thus, the present invention embodiments provide an opportunity for an organization to add an additional facet of revenue to their business model. This can be employed by any organization with a customer base that places telephone calls to the organization for services, information and/or any other purposes.

Upon expiration of the associated time interval, the queue manager unit returns the call to the organization telephone system (e.g., IVR system 35 or call center unit 30) for handling in accordance with the organization normal call handling procedures or policies (e.g., transference to a telephone device 50 of an available representative, transference to a hold queue or IVR system 35, etc.) at step 98. If the time interval for a call within a queue expires prior to completion of a current advertisement or message, the call remains in the queue until completion of that advertisement or message. Thus, sponsors are ensured that advertisements or messages are conveyed to callers in their entireties. Alternatively, the present invention may require a caller to listen to a certain minimum number of advertisements in order to converse with a representative of the called organization. If a representative is unavailable or needs to place a caller on-hold, the call may be transferred back to the advertising system, where the queue manager unit may place the caller in a queue with a shorter time interval in the manner described above to present further messages or advertisements to the caller. The advertising system and queue manager unit may include any quantity of any types of hardware (e.g., processors, circuitry, telephone equipment, switches, etc.) and/or software modules to perform the functions described herein.

The determined revenue (e.g., from step 96) is provided to the organization. The organization may receive or share revenue based on the quantity of calls, quantity of advertisements presented and/or a fixed fee arrangement (e.g., an annual contract, etc.). The revenue may be provided to the organization in any desired fashion (e.g., check, electronically, etc.) and at any desired time intervals (e.g., weekly, monthly, etc.).

It will be appreciated that the embodiments described above and illustrated in the drawings represent only a few of the many ways of implementing a method and apparatus for distributing advertisements to callers during telephone calls.

The network topology employed by the present invention embodiments may include any quantity of components (e.g., servers, networks, gateway units, call centers, telephone or communication devices, ACD systems, IVR systems, etc.) arranged in any fashion. The advertising system employed by the present invention embodiments may include any quantity of any conventional or other telephony equipment (e.g., circuits, switching devices, processors, etc.), and/or any quantity of any personal or other type of computer or processing system (e.g., IBM-compatible, Apple, Macintosh, laptop, palm pilot, etc.) with any commercially available operating system (e.g., Windows, OS/2, Unix, Linux, etc.) and any commercially available or custom software (e.g., communications software, server software, advertising software, etc.). The advertising system may include any types of monitors and input devices (e.g., keyboard, mouse, voice recognition, etc.) to enter and/or view information. The computer or processing systems (e.g., advertising system, etc.) and processors (e.g., of the call center unit, queue manager unit, gateway units, IVR or ACD system, etc.) of the present invention embodiments may alternatively be implemented by any type of hardware and/or other processing circuitry, and may include any quantity of any types of conventional or other hardware (e.g., circuitry, processors, etc.) and/or software modules to perform the functions described herein.

The communication network may be implemented by any quantity of any type of communications network (e.g., LAN, WAN, Internet, Intranet, VPN, etc.). The advertising system and other processing components (e.g., gateway unit, call center unit, queue manager unit, IVR or ACD system, etc.) of the present invention embodiments may include any conventional or other communications devices to communicate over the telephone and/or communications networks via any conventional or other protocols. These devices may utilize any type of connection (e.g., wired, wireless, etc.) for access to the networks.

The telephone network may be implemented by any quantity of any type of communications network providing telephone type or voice service (e.g., Internet, PSTN, analog networks, digital networks, etc.). The telephone or communication devices (e.g., customer, representative, etc.) may be implemented by any conventional or other communication devices enabling voice communication (e.g., wired or wireless communication devices, telephones, laptops with voice technology, etc.). The communication devices of the present invention embodiments may include any conventional or other communications units to communicate over the telephone and/or communications networks via any conventional or other protocols. The communication devices may utilize any type of connection (e.g., wired, wireless, etc.) for access to the networks.

The gateway unit may be implemented by any quantity of any conventional or other gateway device to interface any types of networks employing any types protocols, and may include any conventional or other processing, telephone and/or communications equipment (e.g., processors, routers, etc.) to interface those networks.

The call center unit may be implemented by any quantity of conventional or other call handling devices (e.g., call centers, switchboard, private branch exchange, central office, etc.) and may include any conventional or other processing and/or telephone equipment (e.g., processors, switches, circuitry, etc.) to accommodate calls. The call center unit may include any quantity of any conventional or other hardware and/or software modules to perform the functions described herein, and may utilize any type of connection for communication with the telephone network, communications network, IVR or ACD system and/or advertising system. The call center unit may transfer a call to the advertising system and/or IVR or ACD system based on any criteria. For example, a call may be immediately transferred upon receipt (independent of the availability of a representative to handle the call), may be transferred after any time interval or delay, or may be transferred upon occurrence of a condition (e.g., call placed on-hold, etc.).

Calls may be transferred between the service provider and organization, or access may provided to the service provider or advertising system, in any desired fashion. For example, calls may be provided to the advertising system in the form of conference or any other types of calls to provide advertising or other material to the callers (e.g., forwarded call, re-routed or switched call, conference call, etc.). Further, any types of lines may be used to couple the organization telephone system to the advertising system (e.g., dedicated or semi-dedicated line, private or public network, etc.). The calls may be transferred prior to, during or subsequent normal organization call handling procedures. The caller may control the advertisements or transfer of the calls between the advertising system and organization telephone system based on any type of commands or input (e.g., voice, touch-tone, etc.).

The IVR or ACD system may be implemented by any quantity of any conventional or other call handling and/or distributing devices (e.g., call centers, switchboard, private branch exchange, central office, voice responsive systems, etc.) and may include any conventional or other processing and/or telephone equipment (e.g., processors, switches, circuitry, etc.) to accommodate calls. The IVR or ACD system may include any quantity of any conventional or other hardware and/or software modules to perform the functions described herein, and may utilize any type of connection for communication with the call center unit and/or advertising system. The IVR or ACD system may transfer a call to the advertising system and/or call center unit system based on any criteria. The IVR system may provide any suitable options and/or inquiries to a user (e.g., to receive user information, to transfer a call, to obtain any desired information, etc.) and receive any suitable input as responses (e.g., voice, touch-tones, etc.).

The queue manager unit may be implemented by any quantity of any conventional or other call distribution or hold devices and may include any conventional or other types of hardware (e.g., circuitry, telephone equipment, switches, etc.) and/or software modules to perform the functions described herein. The queue manager unit may utilize any type of connection for communication with the call center unit, telephone network, communications network and/or advertising system. The queue manager unit may include any quantity of queues each including any quantity of calls. The queues may be associated with any desired time interval to retain calls, and/or may retain calls for any quantity of messages or advertisements. The callers in the queue may receive any quantity of any type of information (e.g., advertisements, messages, notices, etc.) and/or any types of queries to ascertain any information about a caller (e.g., physical characteristics, preferences or interests, address, telephone number, etc.). A caller may be screened initially, or may alternatively be screened with each call.

The queue manager unit may place a caller in a queue based on any desired information or combinations of criteria (e.g., age, retired status, purpose of the call, quantity of messages to be presented, etc.). The queue manger unit basically determines a maximum threshold or wait time for a caller and places the caller in the appropriate queue to maximize wait or advertising time and revenue. The queue manager unit may transfer a caller after expiration of the associated time interval, or wait to completion of a currently displayed message or advertisement. The queue manager unit may reside on or be a separate unit in communication with the advertising system. Further, the queue manager unit may reside within the call center unit and/or IVR or ACD system and be in communication with the advertising system to receive and place calls within queues to receive advertisements or other information.

The advertising system may retrieve advertisements or messages for callers based on any caller information or combinations of criteria. For example, messages or advertisements for products may be retrieved and presented to callers based on their interests, age or any other information. The advertising system may determine revenue for an organization based on any desired criteria or combinations of criteria (e.g., quantity of advertisements, quantity of callers, fixed amount, etc.). A service provider, or an organization itself, may provide the advertising service in exchange for revenue. The revenue may be received by the organization from sponsors or from a service provider in any fashion (e.g., manually, electronically, etc.). The fee for advertising or presenting sponsor information may be based on any desired criteria or combinations of criteria (e.g., frequency of presentation, length of advertisement or message, order or placement of the advertisement or message, priority, demographics of callers, etc.).

It is to be understood that the software for the computer systems (e.g., advertising system, etc.) and processors (e.g., of the gateway unit, call center unit, queue manager unit, IVR or ACD system, etc.) of the present invention embodiments may be implemented in any desired computer languages and could be developed by one of ordinary skill in the computer arts based on the drawings and functional descriptions contained in the specification. Further, any references herein of software performing various functions generally refer to computer systems or processors performing those functions under software control. The various functions of the computer systems (e.g., advertising system, etc.) and processors (e.g., of the gateway unit, call center unit, queue manager unit, IVR or ACD system, etc.) of the present invention embodiments may be distributed in any manner among any quantity of software modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the call center unit, queue manager unit, gateway unit, IVR or ACD system and/or advertising system. The software and/or algorithms described above and illustrated in the flow charts or diagrams may be modified in any manner that accomplishes the functions described herein. In addition, the functions in the flow charts or diagrams or description may be performed in any order that accomplishes a desired operation.

The software for the present invention embodiments (e.g., for the call center unit, queue manager unit, IVR or ACD system, advertising system, etc.) may be available on any suitable recordable and/or computer readable medium (e.g., magnetic or optical mediums, magneto-optic mediums, floppy diskettes, CD-ROM, DVD, memory devices, cards, sticks, cartridges, etc.) for use on stand-alone systems or devices, or systems or devices connected by a network or other communications medium, and/or may be downloaded (e.g., in the form of carrier waves, packets, etc.) to systems or devices via a network or other communications medium. The computer or processing systems (e.g., advertising system, etc.) and processors (e.g., of the call center unit, queue manager unit, gateway unit, IVR or ACD system, etc.) of the present invention embodiments may include or be coupled to any conventional or other memory or storage device (e.g., RAM, etc.) of any suitable storage capacity (e.g., kilobytes, megabytes, gigabytes, etc.) to store information.

The present invention is not limited to the specific applications described above, but may be utilized to provide advertising or other information to calls placed to any entities or locations (e.g., any types of businesses, organizations, agencies, private or public residences, etc.).

From the foregoing description, it will be appreciated that the invention makes available a novel method and apparatus for distributing advertisements to callers during telephone calls, wherein remote access to a telephone line of an organization is provided to a service provider to download advertising to parties calling the organization.

Having described preferred embodiments of a new and improved method and apparatus for distributing advertisements to callers during telephone calls, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A system for distributing information to callers during telephone calls comprising:
a call unit associated with an entity to receive incoming calls intended for said entity; and
an information system associated with a service provider and coupled to said call unit to access said calls to said call unit and provide caller intended information to callers, wherein said information system includes a manager unit to determine a wait time interval for callers based on caller related information and said caller intended information is provided to said callers during said wait time interval.

2. The system of claim 1, wherein said caller intended information includes at least one advertisement.

3. The system of claim 2, wherein said manager unit includes a plurality of caller queues each associated with a corresponding wait time interval, and said manager unit assigns callers to said caller queues in accordance with said determined wait time interval, wherein said caller intended information is provided to said callers within said caller queues for said wait time intervals associated with said caller queues.

4. The system of claim 3, wherein said information system provides an advertisement to callers within said caller queues in the advertisement entirety independent of expiration of the corresponding wait time intervals for said caller queues.

5. The system of claim 3, wherein said manager unit further includes at least one inquiry caller queue and said information system provides inquiries to callers within said at least one inquiry caller queue to ascertain caller related information for said wait time interval determination.

6. The system of claim 1, wherein said entity includes a plurality of representatives to provide requested information to callers, and said information system accesses said calls independent of availability of said representatives.

7. The system of claim 6, wherein said call unit handles calls for said entity in accordance with call handling procedures of said entity to provide said calls to said representatives, and said information system accesses said calls prior to said call unit employing said call handling procedures.

8. The system of claim 7, wherein said information system returns a call to said call unit subsequent providing said caller intended information to a corresponding caller to enable said call unit to employ said call handling procedures of said entity to provide said returned call to a representative.

9. The system of claim 8, wherein said call unit provides access to said returned call by said information system in response to said representatives being unavailable.

10. The system of claim 1, wherein said information system is provided access to said calls via at least one of a conference call through a telephone network and a dedicated line between said call unit and said information system.

11. The system of claim 1, wherein said information system is coupled to said call unit by at least one of a communications network, a telephone network and a dedicated line.

12. The system of claim 1, wherein said information system includes a revenue module to determine an amount of revenue for said entity based on at least one of a quantity of callers and a quantity of information provided to said callers.

13. The system of claim 6, wherein said manager unit determines said wait time interval to provide a maximum time interval for callers to receive said caller intended information relative to a caller threshold for terminating a call.

14. The system of claim 1, wherein said entity includes a plurality of representatives to provide requested information to callers and said call unit includes an interactive voice response system to perform at least one of handling calls for said entity in accordance with call handling procedures of said entity to provide said calls to said representatives and providing inquiries to callers to ascertain caller related information.

15. The system of claim 14, wherein said interactive voice response system provides access to said calls by said information system for providing said caller intended information.

16. A method of distributing information to callers during telephone calls comprising:
(a) receiving incoming calls intended for an entity via a call unit associated with said entity; and
(b) accessing said calls to said entity via an information system associated with a service provider to provide caller intended information to callers; and
(c) determining a wait time interval for said callers based on caller related information and providing said caller intended information to said callers during said wait time interval.

17. The method of claim 16, wherein said caller intended information includes at least one advertisement.

18. The method of claim 17, wherein said information system includes a plurality of caller queues each associated with a corresponding wait time interval, and step (c) further includes:
(c.1) assigning callers to said caller queues in accordance with said determined wait time interval and providing said caller intended information to said callers within said caller queues for said wait time intervals associated with said caller queues.

19. The method of claim 18, wherein step (c.1) further includes:
(c.1.1) providing an advertisement to callers within said caller queues in the advertisement entirety independent of expiration of the corresponding wait time intervals for said caller queues.

20. The method of claim 18, wherein said information system further includes at least one inquiry caller queue, and step (c.1) further includes:
(c.1.1) providing inquiries to callers within said at least one inquiry caller queue to ascertain caller related information for said wait time interval determination.

21. The method of claim 16, wherein said entity includes a plurality of representatives to provide requested information to callers, and step (b) further includes:
(b.1) accessing said calls independent of availability of said representatives.

22. The method of claim 21, wherein said call unit handles calls for said entity in accordance with call handling procedures of said entity to provide said calls to said representatives, and step (b.1) further includes:
(b.1.1) accessing said calls prior to said call unit employing said call handling procedures.

23. The method of claim 22 further including:
(d) returning a call from said information system to said call unit subsequent providing said caller intended information to a corresponding caller to enable said call unit to employ said call handling procedures of said entity to provide said returned call to a representative.

24. The method of claim 23 further including:
(e) providing access to said returned call by said information system in response to said representatives being unavailable.

25. The method of claim 16, wherein step (b) further includes:
(b.1) accessing said calls via at least one of a conference call through a telephone network and a dedicated line between said call unit and said information system.

26. The method of claim 16 further including:
(d) determining an amount of revenue for said entity based on at least one of a quantity of callers and a quantity of information provided to said callers.

27. The method of claim 21, wherein step (c) further includes:
(c.1) determining said wait time interval to provide a maximum time interval for callers to receive said caller intended information relative to a caller threshold for terminating a call.

28. The method of claim 16, wherein said entity includes a plurality of representatives to provide requested information to callers and said call unit includes an interactive voice response system, and step (a) further includes:
(a.1) performing, via said interactive voice response system, at least one of handling calls for said entity in accordance with call handling procedures of said entity to provide said calls to said representatives and providing inquiries to callers to ascertain caller related information.

29. The method of claim 28, wherein step (b) further includes:
(b.1) providing said information system access to said calls, via said interactive voice response system, for providing said caller intended information.

30. A system for distributing information to callers during telephone calls comprising:
an information system associated with a service provider to access calls to a call unit associated with an entity and provide caller intended information to callers, wherein said information system includes a manager unit to determine a wait time interval for callers based on caller related information and said caller intended information is provided to said callers during said wait time interval.

31. The system of claim 30, wherein said caller intended information includes at least one advertisement.

32. The system of claim 31, wherein said manager unit includes a plurality of caller queues each associated with a corresponding wait time interval, and said manager unit assigns callers to said caller queues in accordance with said determined wait time interval, wherein said caller intended information is provided to said callers within said caller queues for said wait time intervals associated with said caller queues.

33. The system of claim 32, wherein said information system provides an advertisement to callers within said caller queues in the advertisement entirety independent of expiration of the corresponding wait time intervals for said caller queues.

34. The system of claim 30, wherein said information system is provided access to said calls via at least one of a conference call through a telephone network and a dedicated line between said call unit and said information system.

35. The system of claim 30, wherein said information system includes a revenue module to determine an amount of revenue for said entity based on at least one of a quantity of callers and a quantity of information provided to said callers.

36. The system of claim 30, wherein said manager unit determines said wait time interval to provide a maximum time interval for callers to receive said caller intended information relative to a caller threshold for terminating a call.

37. A method of distributing information to callers during telephone calls comprising:
(a) accessing calls to a call unit associated with an entity via an information system associated with a service provider to provide caller intended information to callers; and
(b) determining a wait time interval for callers based on caller related information and providing said caller intended information to said callers during said wait time interval.

38. The method of claim 37, wherein said caller intended information includes at least one advertisement.

39. The method of claim 37, wherein said manager unit includes a plurality of caller queues each associated with a corresponding wait time interval, and step (b) further includes:
(b.1) assigning callers to said caller queues in accordance with said determined wait time interval and providing said caller intended information to said callers within said caller queues for said wait time intervals associated with said caller queues.

40. The method of claim 39, wherein step (b.1) further includes:
(b.1.1) providing an advertisement to callers within said caller queues in the advertisement entirety independent of expiration of the corresponding wait time intervals for said caller queues.

41. The method of claim 37, wherein step (a) further includes:
(a.1) accessing said calls via at least one of a conference call through a telephone network and a dedicated line between said call unit and said information system.

42. The method of claim 37 further including:
(c) determining an amount of revenue for said entity based on at least one of a quantity of callers and a quantity of information provided to said callers.

43. The method of claim 37, wherein step (b) further includes:
(b.1) determining said wait time interval to provide a maximum time interval for callers to receive said caller intended information relative to a caller threshold for terminating a call.
